(19) United States
(12) Patent Application Publication
(10) Pub. No.: US 2026/0180404 A1
(43) Pub. Date: Jun. 25, 2026

(54) MOTOR SYSTEM

(71) Applicant: MAZDA MOTOR CORPORATION, Hiroshima (JP)

(72) Inventors: Shun OSAWA, Aki-gun (JP); Yoshitomo TAKAHASHI, Aki-gun (JP); Yuma MIYAUCHI, Aki-gun (JP)

(73) Assignee: MAZDA MOTOR CORPORATION, Hiroshima (JP)

(21) Appl. No.: 19/417,447

(22) Filed: Dec. 12, 2025

(30) Foreign Application Priority Data
Dec. 25, 2024 (JP) 2024-228635

(51) Int. Cl. H02K 9/193; B60K 11/04; F16J 15/16; H02K 5/124; H02K 5/20; H02K 11/25

(52) U.S. Cl. CPC H02K 9/193; F16J 15/162; H02K 5/124; H02K 5/203; H02K 11/25; B60K 11/04

(57) ABSTRACT

A motor system for cooling a mechanical seal provided for a rotating shaft of a motor includes the mechanical seal; and a refrigerant circulation circuit that circulates a refrigerant in a refrigerant channel passing through the motor and cools the motor, the refrigerant circulation circuit includes a tank, a compressor, a heat exchanger, and an expansion valve, a cooling jacket passage which causes the refrigerant to flow so as to pass through the vicinity of a fixed ring and/or a secondary seal is formed in a casing, and the refrigerant channel is configured to guide the refrigerant, which is expanded by the expansion valve, at least to the cooling jacket passage.

### CROSS-REFERENCE TO RELATED APPLICATION

The present application claims priority to Japanese Patent Application 2024-228635, filed Dec. 25, 2024, the entire contents of which are incorporated herein by reference.

### FIELD

Embodiments relate to a motor system, particularly to a motor system for cooling a sealing member of a rotating shaft of an electric motor.

### BACKGROUND

A configuration has been suggested which uses a mechanical seal for a shaft penetration portion of an electric motor for motive power (see Patent Literature 1). In general, a mechanical seal is configured such that two annular members (a seal ring and a mating ring) slide in a state where those are pressed onto each other in an axis direction. Thus, because temperatures of the annular members rise due to frictional heat produced on sliding surfaces, the annular members are formed with a material with a high thermal resistant temperature (for example, a ceramic-based material).

Meanwhile, a secondary seal (such as an O ring or a bracket) which configures a part of the mechanical seal is used for mounting the annular members on a structure body (such as a housing or a cover member) or a rotating shaft. The secondary seal can absorb deformation and vibration of a motor system. The secondary seal is formed with a material (such as rubber or a resin, for example) whose thermal resistant temperature is low compared to those of materials which form the structure body (for example, an iron-based material) and the annular members (for example, a ceramic-based material).

Further, in recent years, accompanying attainment of high rotation (for example, exceeding 30,000 rpm) of the electric motor for motive power which is installed in a vehicle, in a case where the mechanical seal is used for such a high rotation motor, a circumferential speed or a rotational speed in a sliding portion of the mechanical member becomes a higher speed. In this case, greater heat is produced in the mechanical seal.

### CITATION LIST

### Patent Literature

[Patent Literature 1] Japanese Patent Laid-Open No. 2022-18909

### SUMMARY

However, in a structure disclosed in Patent Literature 1, because a part of annular members, which are exposed in a motor chamber, in a mechanical seal is cooled by a coolant, it might not be possible to efficiently cool a secondary seal. In particular, as for a high rotation motor in which greater heat is produced in a sliding portion, in the structure disclosed in Patent Literature 1, a temperature of the secondary seal might exceed a thermal resistant temperature. Thus, in the structure in related art, durability of the whole mechanical seal (particularly, the secondary seal) might be impaired.

The embodiments have been made for addressing the above-described issues, and an embodiment may provide a motor system that is capable of effectively cooling a mechanical seal.

To achieve the cooling, an embodiment provides a motor system for cooling a mechanical seal provided for a rotating shaft of a motor, the motor system including: a mechanical seal that has a rotating ring mounted on the rotating shaft and a fixed ring fixed to a casing of the motor via a secondary seal and that is configured such that the rotating ring and the fixed ring abut each other at predetermined pressure in an axis direction of the rotating shaft; and a refrigerant circulation circuit that circulates a refrigerant in a refrigerant channel passing through the motor and cools the motor, characterized in that the refrigerant is a CO₂ refrigerant, the refrigerant circulation circuit includes a tank for storing the refrigerant, a compressor which compresses the refrigerant supplied from the tank, a heat exchanger which causes the compressed refrigerant to dissipate heat, and an expansion valve which expands the refrigerant resulting from heat dissipation, a cooling jacket passage which causes the refrigerant to flow so as to pass through a vicinity of the fixed ring and/or the secondary seal is formed in the casing, and the refrigerant channel is configured to guide the refrigerant, which is expanded by the expansion valve, at least to the cooling jacket passage.

In the embodiment configured in such a manner, a configuration is made such that the cooling jacket passage which causes the refrigerant to pass therethrough for cooling the mechanical seal is formed in the casing and the casing functions as a cooling jacket. In addition, in the present invention, a configuration is made such that the refrigerant at a low temperature and low pressure, which is expanded by the expansion valve, is guided to the cooling jacket passage. In such a configuration, the mechanical seal can effectively be cooled, and degradation of the mechanical seal can be inhibited.

Further, in an embodiment, the cooling jacket passage may have an entrance passage which extends from an inner side surface of the casing along the axis direction and receives the refrigerant; a cooling passage which communicates with the entrance passage, extends around the rotating shaft in the casing, and causes the refrigerant to pass through the cooling passage; and an exit passage which communicates with the cooling passage and is for discharging the refrigerant from the cooling passage. In the present invention configured in such a manner, while stress concentration which can occur in the casing is inhibited by formation of the cooling jacket passage, the mechanical seal mounted on the casing can be cooled by the refrigerant which passes through the cooling jacket passage.

Further, in an embodiment, the motor may have an oil supply unit which blows lubricating oil to a sliding portion of the mechanical seal, and in an inner space, which is surrounded by the casing, of the motor, the exit passage may open in a position to which the lubricating oil is not directly blown from the oil supply unit. In the present invention configured in such a manner, because the refrigerant to be discharged from the exit passage is not obstructed by the lubricating oil to be blown from the oil supply unit, the refrigerant can efficiently be caused to flow through the cooling jacket passage.

Further, in an embodiment, the refrigerant channel may communicate with the cooling jacket passage via an arrangement space, in which the mechanical seal is arranged, in the casing. In the present invention configured in such a manner, before the refrigerant is supplied to the cooling jacket passage, the mechanical seal can be cooled by the refrigerant in a seal arrangement space.

Further, in an embodiment, the refrigerant channel may communicate with the cooling jacket passage not via an arrangement space, in which the mechanical seal is arranged, in the casing. In the present invention configured in such a manner, the refrigerant is efficiently sent to the cooling jacket passage, and the fixed ring and the secondary seal can thereby effectively be cooled.

Further, in an embodiment, the refrigerant circulation circuit may be provided with a delivery valve for controlling a flow of the refrigerant, the motor system may further include a temperature sensor that measures a temperature of the mechanical seal and a controller that controls opening-closing actions of the delivery valve, and in a case where a temperature measured by the temperature sensor is equal to or higher than a predetermined threshold value temperature, the controller may open the delivery valve and causes the refrigerant to flow toward the mechanical seal. In an embodiment configured in such a manner, when the temperature of the mechanical seal is low and cooling by the refrigerant is not necessary, an operation load of the refrigerant circulation circuit is reduced, and power saving can thereby be achieved.

### Advantageous Effects

A motor system according to an embodiment can sufficiently cool a mechanical seal.

### BRIEF DESCRIPTION OF DRAWINGS

FIG. 1 is an outline configuration diagram of a motor system according to an embodiment.

FIG. 2 is an electric block diagram of the motor system according to the embodiment.

FIG. 3 is an explanatory diagram of a refrigeration cycle of the motor system according to the embodiment.

FIG. 4 is a cross-sectional view illustrating a mounting structure of a mechanical seal according to the embodiment.

FIG. 5 is a partial cross-sectional perspective view of an end cover according to the embodiment.

FIG. 6 is an arrow view along line VI-VI in FIG. 5.

FIG. 7 is a partial cross-sectional perspective view of a casing according to the embodiment.

FIG. 8 is a flowchart illustrating a processing flow of the motor system according to the embodiment.

FIG. 9 is a graph illustrating a relationship between a motor speed and a temperature of the mechanical seal.

FIG. 10 is a time chart of various physical quantities accompanying the processing flow of the motor system according to the embodiment.

FIG. 11 is a partial cross-sectional view of an end cover according to a modification example of the embodiment.

FIG. 12 is a cross-sectional view illustrating a mounting structure of a mechanical seal according to a modification example of the embodiment.

### DETAILED DESCRIPTION

A motor system according to embodiments will hereinafter be described with reference to the attached drawings.

### Configuration of System

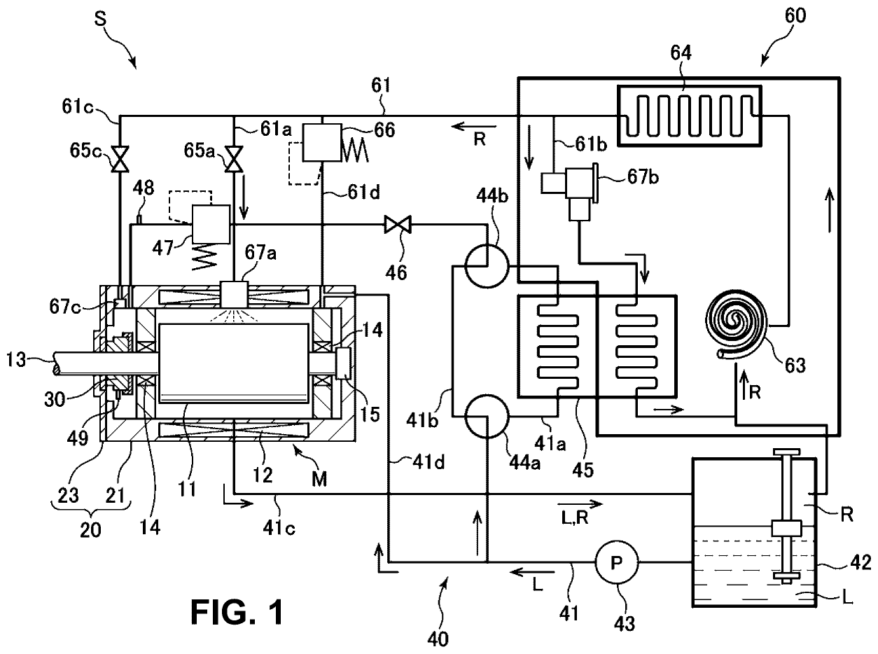

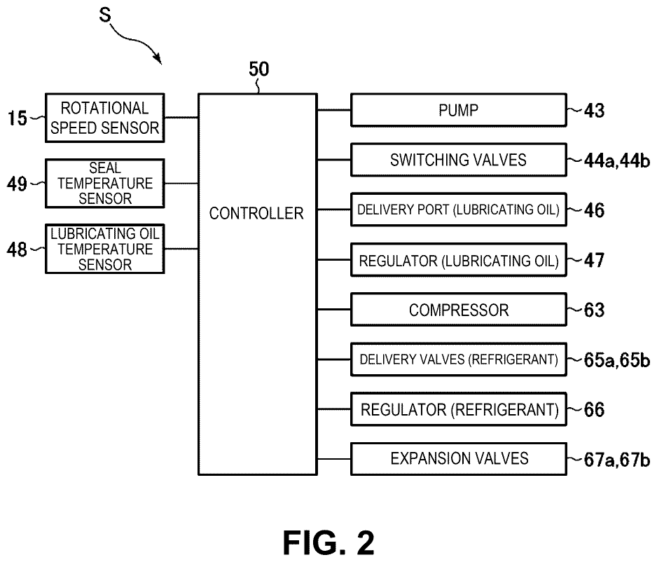

First, a general configuration of a motor system S according to the present embodiment will be described with reference to FIG. 1 and FIG. 2. FIG. 1 is an outline configuration diagram of the motor system according to the present embodiment, and FIG. 2 is an electric block diagram of the motor system. The motor system S illustrated in FIG. 1 is configured to execute supply of lubricating oil to a mechanical seal which is incorporated in a motor M used for driving of a vehicle such as an electric automobile and supply of a refrigerant to the motor M (particularly, a stator and a rotor), for example.

Thus, the motor system S includes a refrigerant circulation circuit 60 for circulating a refrigerant R in the motor M and thereby cooling the motor M. In the present embodiment, the refrigerant R is a natural refrigerant such as a CO₂ refrigerant, for example. Further, the motor system S includes a lubricating oil circulation circuit 40 for circulating lubricating oil L through a mechanical seal 30 and bearings 14 and thereby lubricating the mechanical seal 30 and the bearings 14.

Various kinds of configuration elements are arranged on piping (or channel) 41, and the lubricating oil circulation circuit 40 is thereby configured. On the channel 41, a tank 42 which stores the lubricating oil L, a pump 43 which pressure-feeds the lubricating oil L in the tank 42, two switching valve 44a and 44b, a lubricating oil heat exchange unit 45, an arbitrary delivery valve 46, an arbitrary regulator 47, and the motor M are provided. On a downstream side relative to the regulator 47, a lubricating oil temperature sensor 48 is arranged which measures a lubricating oil temperature TL of the lubricating oil L flowing into the motor M. In addition, in the motor M, a seal temperature sensor 49 is arranged which detects a seal temperature T around the mechanical seal 30.

The channel 41 branches into a first branch channel 41a and a second branch channel 41b between the switching valves 44a and 44b. The first branch channel 41a is a channel for cooling in which the lubricating oil heat exchange unit 45 is arranged. The second branch channel 41b is a channel for bypassing. Each of the switching valves 44a and 44b is configured to selectively operate in conjunction with a valve position for cooling (cooling position) and a valve position for bypassing (bypassing position). Each of the switching valves 44a and 44b causes the lubricating oil L to be pressure-fed from the pump 43 to pass through the first branch channel 41a at the cooling position and to pass through the second branch channel 41b at the bypassing position. Note that each of the switching valves 44a and 44b may usually be set to the bypassing position.

The lubricating oil heat exchange unit 45 is configured to perform heat exchange between the refrigerant R, which flows through the refrigerant circulation circuit 60, and the lubricating oil L and to thereby cool the lubricating oil L. That is, in the lubricating oil heat exchange unit 45, heat exchange is performed while the lubricating oil L and the refrigerant R are passing through separate pieces of piping, and the lubricating oil L is thereby cooled by the refrigerant R at a low temperature.

The delivery valve 46 is an opening-closing valve which opens and closes the channel 41 and switches sending and stop of the lubricating oil L. The regulator 47 is a pressure regulating valve, reduces a sending pressure by the pump 43 to predetermined pressure, and thereby regulates a flow amount.

In the lubricating oil circulation circuit 40, the lubricating oil L is supplied by the pump 43 from an inside of the tank 42 toward a downstream portion of the channel 41. The lubricating oil L passes through the first branch channel 41a or the second branch channel 41b, is thereafter supplied into the motor M, and lubricates the mechanical seal 30 in the motor M. The lubricating oil L which has lubricated the mechanical seal 30 passes, from a discharge portion of the motor M, through a channel 41c for discharge and returns to the tank 42.

Further, the channel 41 has a channel 41d which branches in a downstream portion relative to the pump 43. The lubricating oil L which flows through the channel 41d is supplied to the bearings 14 of the motor M without flowing toward the switching valve 44a. The lubricating oil L which has lubricated the bearings 14 flows into the channel 41c from the discharge portion, together with the lubricating oil L which has lubricated the mechanical seal 30.

The refrigerant circulation circuit 60 is configured to share a part of configuration elements with the lubricating oil circulation circuit 40. The refrigerant circulation circuit 60 forms a refrigeration cycle with the refrigerant R (CO₂ refrigerant) and includes, on piping (or channel) 61, the tank 42 which stores the lubricating oil L and the refrigerant R, a compressor 63 which compresses the refrigerant R, a heat exchanger (condensing device) 64 which includes a condenser, a fan, and so forth, delivery valves 65a and 65c, an arbitrary regulator 66, an expansion valve 67a (first expansion valve), an arbitrary expansion valve 67b (second expansion valve), an expansion valve 67c (third expansion valve), and the motor M, lubricating oil heat exchange unit 45, and cooling jacket passage 25 which serve as an evaporator.

The tank 42 is configured to store both of the lubricating oil L and the refrigerant R, and in the tank 42, the lubricating oil L as a liquid and the refrigerant R (CO₂ refrigerant) as gas are separated in an up-down direction. Consequently, in the lubricating oil circulation circuit 40, the lubricating oil L can be taken out from a lower portion of the tank 42, and in the refrigerant circulation circuit 60, the refrigerant R can be taken out from an upper portion of the tank 42.

In the present embodiment, in a downstream portion relative to the heat exchanger 64, the channel 61 includes a first channel 61a, a second channel 61b, and a third channel 61c which respectively branch toward the expansion valve 67a, the expansion valve 67b, and the expansion valve 67c. The first channel 61a communicates with an inner space of the motor M, ejects the refrigerant R, which has passed through the expansion valve 67a, toward the rotor and the stator, and thereby cools those. The third channel 61c communicates with the cooling jacket passage 25 for the mechanical seal 30 and cools the mechanical seal 30 by the refrigerant R which has passed through the expansion valve 67c. The refrigerant R which has cooled the motor M and the mechanical seal 30 passes, from the discharge portion of the motor M, through the channel 41c for discharge and returns to the tank 42, similarly to the lubricating oil L.

Further, the second channel 61b passes through the expansion valve 67b and the lubricating oil heat exchange unit 45 and merges with the channel 61 between the tank 42 and compressor 63. The refrigerant R passing through the expansion valve 67b performs heat exchange with the lubricating oil L at the lubricating oil heat exchange unit 45 and cools the lubricating oil L.

In the present embodiment, each of the expansion valves 67a and 67b is an electronic expansion valve whose valve opening degree is electronically controllable. The expansion valve 67a can be mounted on the channel 61 or a casing 20. Meanwhile, the expansion valve 67c is a narrow hole provided in the casing 20. The refrigerant R expands when passing through the narrow hole and flowing into the inner space (seal arrangement space F) in the motor M. However, the expansion valve 67c may also be an electronic expansion valve which is mounted on the channel 61 or the casing 20. However, the expansion valve 67a may be of an integrated type which is integrated with the casing 20, and in this case, the expansion valve 67a may be an electronic expansion valve or may be a narrow hole which is mounted on the casing 20.

Note that in the present embodiment, the expansion valve 67b is provided; however, this is not restrictive, and the first channel 61a is provided so as to branch from a downstream portion relative to the expansion valve 67a and to guide the refrigerant R to the lubricating oil heat exchange unit 45, and a configuration may thereby be made which is not provided with the expansion valve 67b.

Further, in the present embodiment, the channel 61 includes a fourth channel 61d which branches from the channel 61 as a main stream in a downstream portion relative to the heat exchanger 64. The refrigerant R flowing through the fourth channel 61d is depressurized to predetermined pressure by the regulator 66 and thereafter merges with the lubricating oil L flowing through the channel 41d or is separately supplied to the bearings 14 of the motor M. Note that in a case where it is not necessary to cool the bearings 14 by the refrigerant R, a configuration may be made which is not provided with the fourth channel 61d or the regulator 66.

In the refrigerant circulation circuit 60, the refrigerant R in the tank 42 passes through the compressor 63, the heat exchanger 64, and the expansion valves 67a and 67c, is supplied into the motor M, and cools configuration components (particularly, the stator, the rotor, and the mechanical seal 30) in the motor M. The refrigerant R which has cooled the motor M passes, from the discharge portion of the motor M, through the channel 41c for discharge and returns to the tank 42, similarly to the lubricating oil L.

### Configuration of Motor

The motor M according to the present embodiment is a high rotational speed motor and is configured to operate at a high rotational speed exceeding 30,000 rpm, for example. The motor M includes a rotor 11, a stator 12, a rotating shaft (rotor shaft) 13 which is fixed to the rotor 11 and extends in an axis direction, a pair of bearings (sliding bearings) 14 which rotatably support the rotating shaft 13, the casing 20 which houses and supports those rotor 11, stator 12, rotating shaft 13, bearings 14, and so forth, and the mechanical seal 30 which seals a portion between the casing 20 and the rotating shaft 13. One end of the rotating shaft 13 is connected to a transaxle or the like of the vehicle. Further, the motor M arbitrarily includes a rotational speed sensor or an angle sensor (resolver) 15 for detecting a rotor rotational speed of the rotating shaft 13. The casing 20 includes a housing 21 which houses the rotor 11 and so forth and an end cover 23 which blocks an opening of an axis-direction end portion of the housing 21.

The stator 12 having a generally cylindrical shape is configured with a coil wound around a stator core. The rotor 11 has a rotor core and a plurality of permanent magnets mounted on the rotor core. The rotating shaft 13 is fixed to the rotor core. The rotor 11 is configured to be rotatable together with the rotating shaft 13 in the stator 12.

The mechanical seal 30 tightly seals a portion between an end portion of the rotating shaft 13 and the end cover 23 and prevents leakage of the refrigerant R and the lubricating oil L from an internal portion of the casing 20 to an outside. Further, in the casing 20, as the channels 41 and 61, an internal channel which receives the lubricating oil L from the outside and guides that to the mechanical seal 30 and the bearings 14, an internal channel which receives the refrigerant R from the outside and guides that to an internal portion of the motor M and the bearings 14, and an internal channel as the discharge portion which guides the lubricating oil L and the refrigerant R to the channel 41c for discharge are formed.

As illustrated in FIG. 2, the motor system S includes a controller 50 as a computer (e.g., a control computer) which has a processor, a memory, and so forth, receives signals (such as a rotor rotation angle, a seal temperature, and a lubricating oil temperature) from various sensors, and outputs an operation signal to each configuration element of the lubricating oil circulation circuit 40 and the refrigerant circulation circuit 60. In the present embodiment, the refrigerant circulation circuit 60 is configured to always operate during an operation of the motor M.

### Refrigeration Cycle by Refrigerant

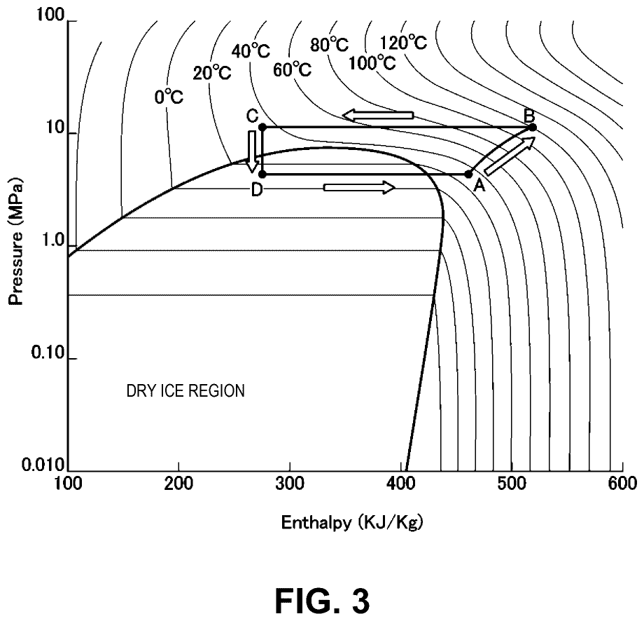

Next, the refrigeration cycle by the refrigerant R in the present embodiment will be described with reference to FIG. 3. FIG. 3 is a p-h chart of the CO₂ refrigerant, the horizontal axis represents enthalpy, and the vertical axis represents pressure. The CO₂ refrigerant becomes a supercritical fluid when pressure and a temperature are raised from an ambient environment (an ordinary temperature and 1 atm) and exceed a critical point (31° C. and 7.4 MPa).

First, in the refrigeration cycle (A-B-C-D) of the present embodiment, a compression step (A-B) by the compressor 63 is performed. The compressor 63 is of a rotary type and receives the CO2 refrigerant R (gas, superheated vapor) at an intermediate temperature and low pressure (for example, 30° C. and 4.2 MPa) from the tank 42 via the channel 61 (point A), compresses the received refrigerant R, and delivers the CO₂ refrigerant R (supercritical fluid) at a high temperature and high pressure (for example, 120° C. and 12 MPa) (point B).

Next, a cooling step (B-C) by the heat exchanger 64 is performed. The heat exchanger 64 receives the CO₂ refrigerant R at the high temperature and high pressure (point B), performs heat exchange with an external environment (such as cool wind or cooling water), and generates the CO₂ refrigerant R (supercritical fluid) at an intermediate temperature and high pressure (for example, 35° C. and 12 MPa) (point C). Next, an expansion step (C-D) by the expansion valve 67a (or expansion valve 67b) is performed for the CO₂ refrigerant R at the intermediate temperature and high pressure. The CO₂ refrigerant R expands by the expansion step and becomes the CO₂ refrigerant R (gas-liquid mixture, wet vapor) at a low temperature and low pressure (for example, 10° C. and 4.2 MPa) (point D).

In addition, in the internal portion of the motor M (or the lubricating oil heat exchange unit 45), an evaporation step (D-A) is performed. In the casing 20, the CO₂ refrigerant R at the low temperature and low pressure evaporates by performing heat exchange with a high temperature portion of the motor M (or the lubricating oil L in the lubricating oil heat exchange unit 45) and becomes the CO₂ refrigerant R (gas, superheated vapor) at an intermediate temperature and low pressure. This CO₂ refrigerant R at the intermediate temperature and low pressure is returned to the compressor 63 (point A).

### Mounting Structure of Mechanical Seal

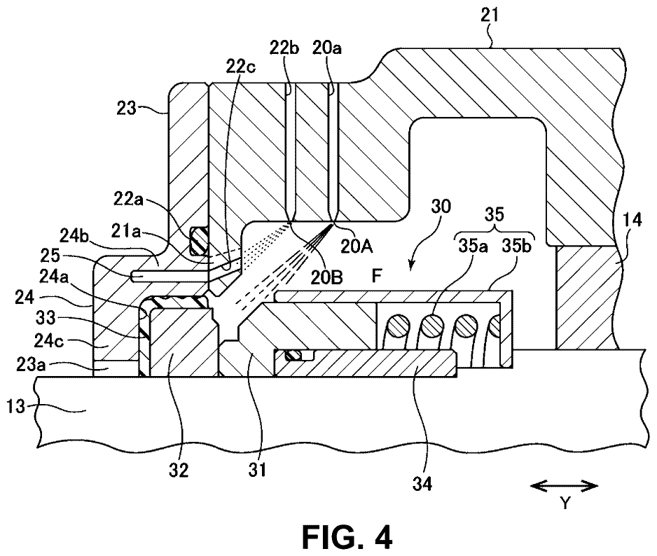

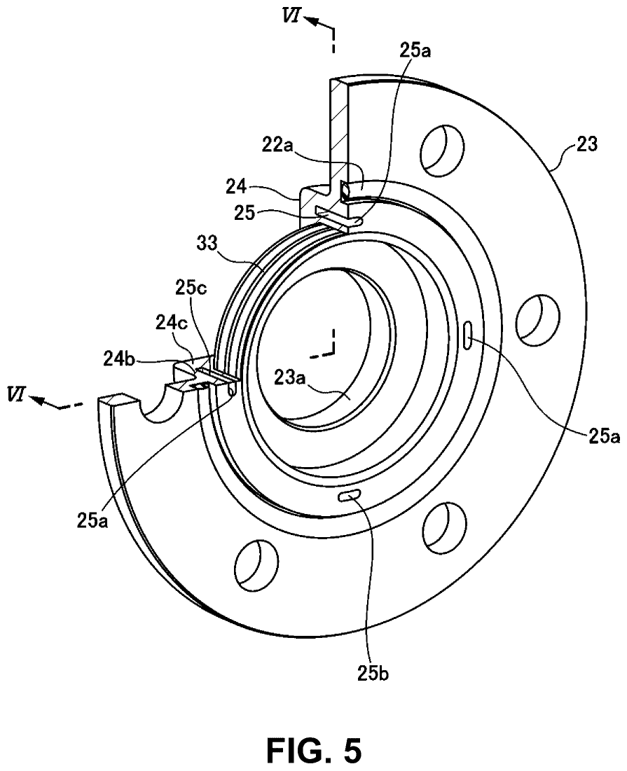

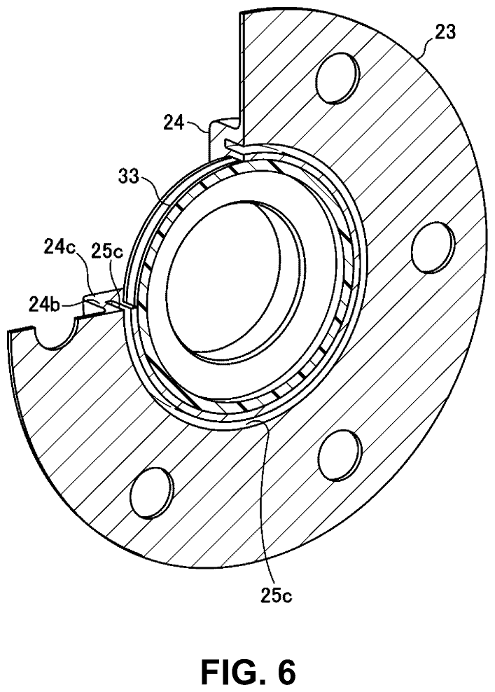

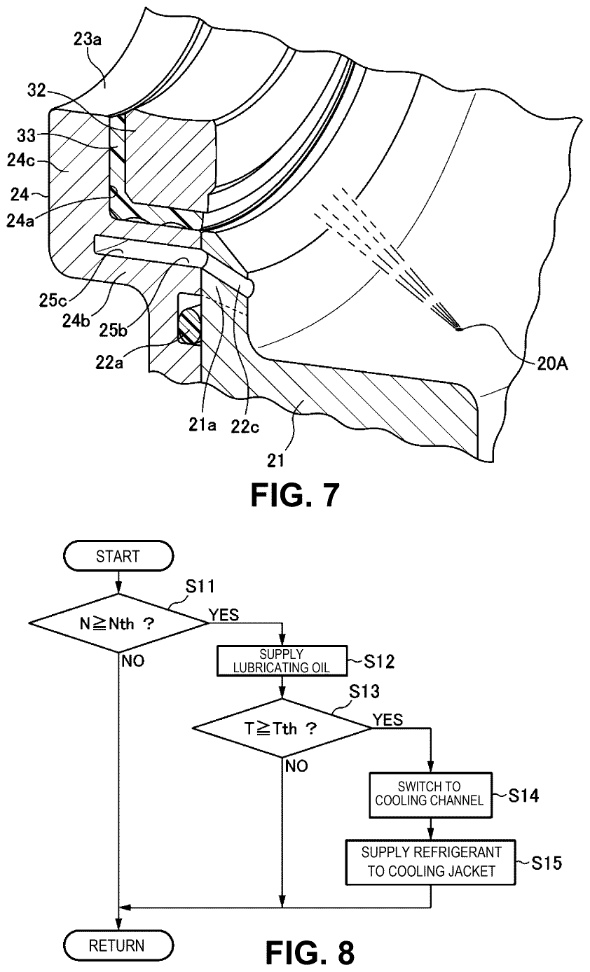

Next, a mounting structure of the mechanical seal according to the present embodiment will be described with reference to FIG. 4 to FIG. 7. FIG. 4 is a cross-sectional view illustrating the mounting structure of the mechanical seal, FIG. 5 is a partial cross-sectional perspective view of the end cover, FIG. 6 is an arrow view along line VI-VI in FIG. 5, and FIG. 7 is a partial cross-sectional perspective view of the casing.

As illustrated in FIG. 4, the end cover 23 is fixed to an end portion of the housing 21, and in an internal portion of the housing 21, the seal arrangement space F in which the rotating shaft 13 extends in an axis direction Y is provided between the bearing 14 and the end cover 23. The mechanical seal 30 is arranged in the seal arrangement space F. The end cover 23 has a disk shape and is screwed to the housing 21, with an O ring 22a interposed therebetween, in a tightly sealing state. The end cover 23 has, in its central portion, a cylindrical bulging portion 24 which protrudes toward an outer side in the axis direction Y. A through hole 23a through which the rotating shaft 13 is inserted is formed in the bulging portion 24, and the bulging portion 24 forms a recess 24a for mounting the mechanical seal 30 in an internal portion. The bulging portion 24 has a peripheral wall 24b which extends from a base portion in the axis direction Y and a torus-shaped (donut-shaped) lid portion 24c which extends from a distal end portion of the peripheral wall 24b toward the rotating shaft 13 on a radial-direction inner side and has the through hole 23a.

The rotating shaft 13 which is rotatably supported by the bearings 14 passes through the seal arrangement space F, passes through the through hole 23a provided in the end cover 23, and extends to the outside of the motor M. The mechanical seal 30 is configured to tightly seal a portion between the seal arrangement space F and the outside of the motor M (particularly, a gap between the rotating shaft 13 and the through hole 23a).

The mechanical seal 30 includes a rotating ring 31 which is mounted on the rotating shaft 13, a secondary seal 33 which is mounted by being fitted into the recess 24a formed in the end cover 23, and a fixed ring 32 which is fixed to the end cover 23 via the secondary seal 33. Each of the rotating ring 31 and the fixed ring 32 is an annular component which has a through hole extending in the axis direction Y and is formed of a material with high wear resistance (for example, a ceramic-based material). The rotating shaft 13 is inserted through those through holes.

The rotating ring 31 is integrated with a cylindrical sliding member 34, which is slidably attached to the rotating shaft 13, and is movable together with the sliding member 34 on the rotating shaft 13 in the axis direction Y. Further, the rotating ring 31 is pressed or urged toward the outside of the motor M in the axis direction Y by an urging member 35 which is fixed to the rotating shaft 13. The urging member 35 has a coil spring 35a which is attached to the rotating shaft 13 and a cylindrical annular member 35b which is fixed to the rotating shaft 13. The coil spring 35a is compressed between the annular member 35b and the rotating ring 31 in the axis direction Y and always presses the rotating ring 31 to the annular member 35b in the axis direction Y. Accordingly, the rotating ring 31 and the fixed ring 32 abut each other with predetermined pressure in the axis direction Y.

The fixed ring 32 is mounted by being fitted into the recess 24a, which is formed in the end cover 23, together with the secondary seal 33. The secondary seal 33 is a component which has a bottomed cylindrical shape and is to be attached to the fixed ring 32, and similarly to the fixed ring 32, a through hole through which the rotating shaft 13 passes is formed in a bottom portion. The secondary seal 33 is formed of a material having predetermined elasticity (such as rubber or a resin, for example). A thermal resistant temperature of the secondary seal 33 is lower than those of ceramic-based materials which form the rotating ring 31 and the fixed ring 32 and a metal-based material (particularly, an iron-based material) which forms the casing 20. The secondary seal 33 tightly seals a portion between the fixed ring 32 and the recess 24a of the end cover 23 and absorbs vibration or the like of the rotating shaft 13.

The rotating ring 31 and the fixed ring 32 contact with each other on their sliding surfaces at predetermined surface pressure by the urging member 35. When the rotating ring 31 rotates together with the rotating shaft 13, the sliding surfaces of the fixed ring 32 and the rotating ring 31 slidably contact with each other in a state where the predetermined surface pressure is exerted. Accordingly, frictional heat is produced in the sliding surfaces, and temperature rises occur in the rotating ring 31 and the fixed ring 32.

Further, in the housing 21, as the channel 41 of the lubricating oil circulation circuit 40, internal channels 20a which guide the lubricating oil L to the seal arrangement space F are formed in a plurality of parts in a circumferential direction. Further, in the housing 21, as the channel 61 of the refrigerant circulation circuit 60, internal channels 22b which guide the refrigerant R to the seal arrangement space F are formed in a plurality of parts in the circumferential direction. In addition, in the housing 21, a plurality of internal channels 22c are formed from the seal arrangement space F toward the bulging portion 24. Meanwhile, in the end cover 23, the cooling jacket passage 25 is formed which is for cooling the fixed ring 32 and the secondary seal 33 by the refrigerant R which is guided through the internal channels 22b. Consequently, the bulging portion 24 functions as a cooling jacket. In the present embodiment, the cooling jacket passage 25 is formed along the peripheral wall 24b of the bulging portion 24.

Note that in the present embodiment, because the end cover 23 is configured to support the fixed ring 32 and the secondary seal 33, the cooling jacket passage 25 is provided in the end cover 23; however, this is not restrictive, and in a case where the housing 21 is configured to support the fixed ring 32 and the secondary seal 33, the cooling jacket passage 25 can be provided in the housing 21.

As illustrated in FIG. 5 and FIG. 6, the cooling jacket passage 25 has three entrance passages 25a and one exit passage 25b, which are holes communicating or in fluid communication with the internal channels 22c and extending from the base portion (a surface on the seal arrangement space side) in the axis direction Y, and a cooling passage 25c, which communicates with the entrance passages 25a and the exit passage 25b and extends along the peripheral wall 24b at least in the circumferential direction. Note that the cooling passage 25c may be formed to be connected from the peripheral wall 24b to the lid portion 24c. Consequently, the cooling passage 25c extends at least in the circumferential direction of the secondary seal 33 or the rotating shaft 13.

In the present embodiment, among the four holes, the entrance passages 25a are holes as the three holes (12 o'clock, 3 o'clock, and 9 o'clock in a front view) which include the highest position in a perpendicular direction, and the exit passage 25b is a hole at the lowest position (6 o'clock position in the front view) in the perpendicular direction.

In an example illustrated in FIG. 4, the internal channels 20a and 22b, which extend from an upper area to a lower area, open to the seal arrangement space F respectively with injection holes 20A and 20B whose distal ends are thin. Further, in the housing 21, the separate internal channels 22c are formed so as to be continuous from the seal arrangement space F to the peripheral wall 24b of the end cover 23. The injection holes 20A and 20B are formed to inject the lubricating oil L and the refrigerant R with respective predetermined directivities. The injection hole 20B of the refrigerant R functions as the expansion valve 67c. That is, the refrigerant R at the intermediate temperature and high pressure expands when being blown out from the injection hole 20B to the seal arrangement space F and becomes the refrigerant R at the low temperature and low pressure. However, regardless of presence or absence of the injection hole 20B, a configuration may be employed in which the expansion valve 67c as the electronic expansion valve is arranged on the outside of the seal arrangement space F and the refrigerant R at the low temperature and low pressure, which is output from the expansion valve 67c, is supplied through the internal channels 22b.

The lubricating oil L passes through the internal channels 20a, is directionally injected to the mechanical seal 30 (particularly, sliding portions of the rotating ring 31 and the fixed ring 32) in the seal arrangement space F by the injection holes 20A, and thereby lubricates the mechanical seal 30. Further, the refrigerant R, which passes through the internal channels 22b and is injected from the injection holes 20B, is injected in an injection pattern in which the refrigerant R is directed toward openings of the separate internal channels 22c, passes through the internal channels 22c, and is guided to the entrance passages 25a formed in the end cover 23.

The refrigerant R enters the cooling passage 25c from the entrance passages 25a, cools the fixed ring 32 and the secondary seal 33 from the circumferential direction, passes, from the exit passage 25b, through the internal channels 22c, and is again discharged to the seal arrangement space F. Note that as illustrated in FIG. 7, the injection hole 20A is arranged in such a position that the injection hole 20A does not inject the lubricating oil L toward the exit passage 25b (and the internal channels 22c communicating with the exit passage 25b) and is set to have such a directional injection pattern that the injection hole 20A does not inject the lubricating oil L toward the exit passage 25b.

Note that in the present embodiment, the housing 21 blocks, by an annular blocking portion 21a, an axis-direction base portion of the peripheral wall 24b of the bulging portion 24 of the end cover 23, and the separate internal channels 22c are formed in the blocking portion 21a. The separate internal channels 22c communicate with the entrance passages 25a. However, a configuration may be made such that by removing at least a part of the blocking portion 21a, at least a part of the axis-direction base portion of the peripheral wall 24b of the bulging portion 24 is not blocked by the housing 21. In such a configuration, the separate internal channels 22c do not have to be formed.

Note that in the present embodiment, the fixed ring 32 fixed to the casing 20 is the mating ring which does not move in the axis direction Y, and the rotating ring 31 mounted on the rotating shaft 13 is the seal ring which is movable in the axis direction Y; however, this is not restrictive, and a configuration may be made in which the fixed ring 32 is used as the seal ring and the rotating ring 31 is used as the mating ring.

### Control Flow

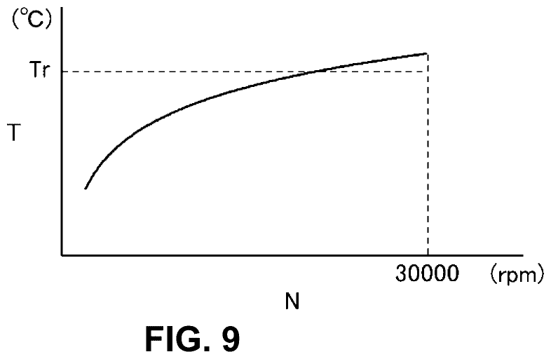

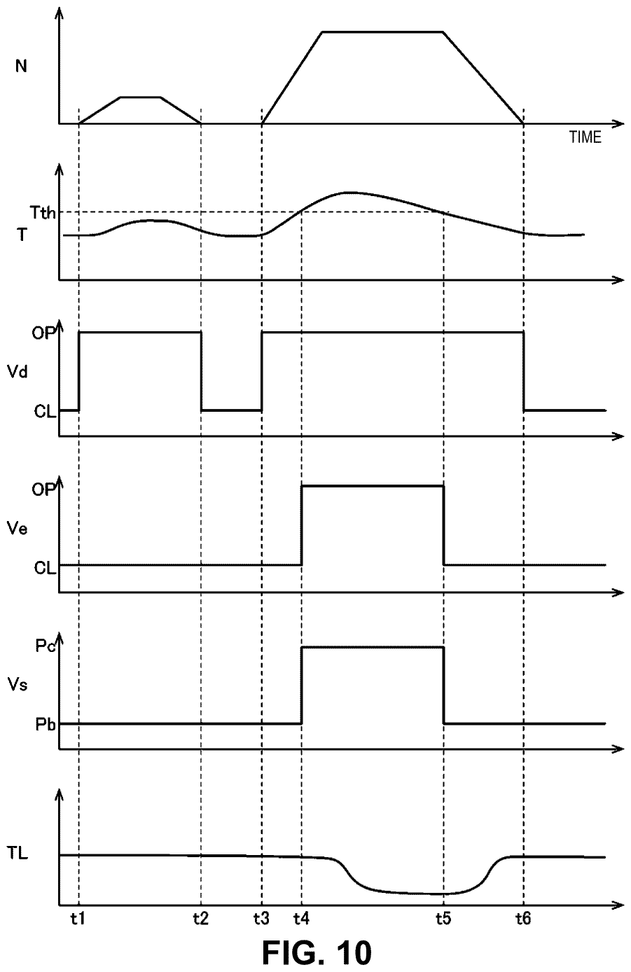

Next, a processing flow of the motor system S of the present embodiment will be described with reference to FIG. 8 to FIG. 10. FIG. 8 is a flowchart illustrating the processing flow of the motor system, FIG. 9 is a graph illustrating a relationship between a motor speed and a temperature of the mechanical seal, and FIG. 10 is a time chart of various physical quantities accompanying the processing flow.

The controller 50 repeatedly performs the processing flow in FIG. 8 for performing cooling of the mechanical seal at predetermined intervals. The controller 50 always receives signals from various sensors and determines whether or not a motor speed N is equal to or higher than a predetermined threshold value rotational speed Nth (S11). Specifically, based on a rotor rotation angle signal received from an angle sensor 15, the controller 50 can calculate the motor speed N of the rotating shaft 13. In the present embodiment, except an extremely low rotational speed which occurs immediately after a start of the motor M and immediately before a stop, the threshold value rotational speed Nth is set such that an affirmative determination is made. The threshold value rotational speed Nth is set in a range of 50 to 100 rpm, for example.

In a case where a negative determination is made in step S11 (No in S11), the controller 50 finishes the process. On the other hand, in a case where an affirmative determination is made in step S11 (Yes in S11), the controller 50 operates the pump 43 and pressure-feeds the lubricating oil L toward the motor M (S12). In this case, the controller 50 maintains the valve position of each of the switching valves 44a and 44b in the valve position for bypassing, causes the lubricating oil L to pass through the second branch channel 41b, retains the delivery valve 46 in an open state, and operates the regulator 47 such that the lubricating oil L is depressurized to predetermined pressure.

Next, the controller 50 determines whether or not the seal temperature T of the mechanical seal 30 is equal to or higher than a predetermined threshold value temperature Tth (S13). In addition, the controller 50 can receive the seal temperature T around the mechanical seal 30 from the seal temperature sensor 49. The threshold value temperature Tth is set lower than a thermal resistant temperature Tr (for example, 150° C.) of the secondary seal 33, whose thermal resistant temperature is low, among configuration components of the mechanical seal 30. The threshold value temperature Tth is set in a range of 50° C. to 140° C., for example, or a temperature range which is lower than the thermal resistant temperature Tr by a predetermined temperature (for example, 100° C. to 10° C.).

The motor M in the present embodiment is a motor which operates at a high rotational speed exceeding 30,000 rpm, for example, and degradation due to a temperature rise of the mechanical seal 30 becomes a problem. FIG. 9 illustrates a measurement result of use of a predetermined mechanical seal, and it can be understood that in a case where no cooling process is performed, as the motor speed becomes higher, the temperature of the mechanical seal rises. In FIG. 9, it can be understood that for example, at 30,000 rpm, the temperature of the mechanical seal exceeds the thermal resistant temperature Tr of the secondary seal.

Accordingly, in the present embodiment, a configuration is made such that when the seal temperature T of the mechanical seal 30 reaches the threshold value temperature Tth which is lower than the thermal resistant temperature Tr of the secondary seal 33 by the predetermined temperature, the refrigerant R at a low temperature is supplied to the cooling jacket passage 25, the lubricating oil L which has been cooled by the lubricating oil heat exchange unit 45 is injected to the mechanical seal 30, and the seal temperature T of the mechanical seal 30 (particularly, the secondary seal 33) thereby does not reach the thermal resistant temperature Tr.

In a case where a negative determination is made in step S13 (No in S13), the controller 50 finishes the process. That is, during a period in which the seal temperature T of the mechanical seal 30 is low, the refrigerant R is not provided to the cooling jacket passage 25, and the lubricating oil L is supplied to the mechanical seal 30 without being cooled by the lubricating oil heat exchange unit 45. Accordingly, an operation load of the compressor 63 or the like is reduced, and power saving can thereby be achieved.

On the other hand, in a case where an affirmative determination is made in step S13 (Yes in S13), the controller 50 switches a valve position Vs of each of the switching valves 44a and 44b to a valve position Vc for cooling (S14) and causes the lubricating oil L to pass through the first branch channel 41a. Accordingly, the lubricating oil L performs heat exchange with the refrigerant R at the lubricating oil heat exchange unit 45 and is cooled. Consequently, because the lubricating oil L which has been cooled by the refrigerant R is supplied to the mechanical seal 30, the sliding portions of the mechanical seal 30 are more efficiently cooled, and the secondary seal 33 is thereby inhibited from reaching the thermal resistant temperature Tr.

In addition, the controller 50 switches a valve position of the delivery valve 65c from a closed position to an open position (step S15) and supplies the refrigerant R at a low temperature and low pressure to the cooling jacket passage 25. Accordingly, the mechanical seal 30 (particularly, the fixed ring 32 and the secondary seal 33) is effectively cooled, and the secondary seal 33 is thereby inhibited from reaching the thermal resistant temperature Tr.

Referring to the time chart in FIG. 10, the rotor 11 rotates from times t1 to t2, and in conjunction with this, a valve opening degree Vd of the delivery valve 46 is changed from a closed position (CL) to an open position (OP). However, because the seal temperature T of the mechanical seal 30 is low (T<Tth), a valve position Ve of the delivery valve 65c of the refrigerant R is maintained in a closed position CL, and the valve position Vs of each of the switching valves 44a and 44b is maintained in a bypassing position Pb.

Further, the rotor 11 rotates from other times t3 to t6, and in conjunction with this, the valve opening degree Vd of the delivery valve 46 is maintained in the open position (OP). In this period, when the seal temperature T of the mechanical seal 30 reaches the threshold value temperature Tth at a time t4, the valve position Ve of the delivery valve 65c of the refrigerant R is switched from the closed position CL to the open position OP, and the valve position Vs of each of the switching valves 44a and 44b is switched from the bypassing position Pb to a cooling position Pc. Accordingly, the refrigerant R at a low temperature is supplied to the cooling jacket passage 25 after the time t4, the lubricating oil L is cooled by the lubricating oil heat exchange unit 45, and the lubricating oil temperature TL lowers. Accompanying this, when the seal temperature T of the mechanical seal 30 lowers to a temperature lower than the threshold value temperature Tth at a time t5, the valve position Ve of the delivery valve 65c is again switched to the closed position CL, and the valve position Vs of each of the switching valves 44a and 44b is again switched to the bypassing position Pb.

### Modification Example of Cooling Jacket Passage

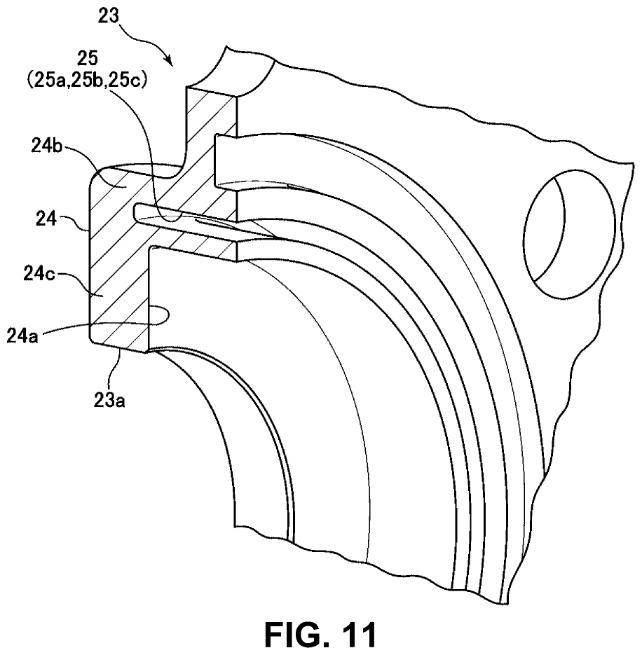

Next, an embodiment according to a modification example of an embodiment will be described with reference to FIG. 11. In the end cover 23 according to the modification example in FIG. 11, the entrance passage 25a and the exit passage 25b are connected together in the circumferential direction and are formed into an annular shape similarly to the annular cooling passage 25c. In such a configuration as well, similarly to a case illustrated in FIG. 4, the refrigerant R injected from the injection holes 20B reaches the entrance passage 25a through the separate internal channels 22c, passes, from the exit passage 25b, through the separate internal channel 22c in a lower area, and is discharged to the outside.

### Modification Example of Mounting Structure of Mechanical Seal

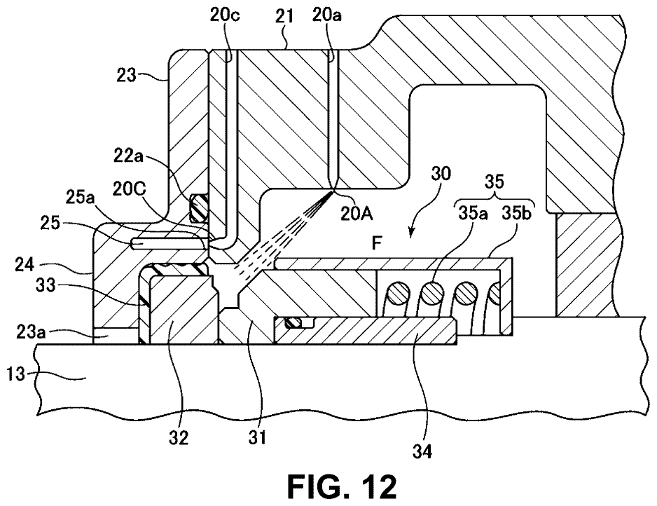

Next, an embodiment according to a modification example of an embodiment will be described with reference to FIG. 12. In an example in FIG. 12, the internal channel 22b directly communicates with the cooling jacket passage 25 and supplies the lubricating oil L to the housing 21. In this embodiment, similarly to the internal channel 20a, the internal channel 22b extends through the housing 21 but does not open to the seal arrangement space F and is directly coupled to the entrance passage 25a formed in the end cover 23. The internal channel 22b opens to the entrance passage 25a through an injection hole 20C whose distal end is thin. The injection hole 20C functions as the expansion valve 67c. That is, the refrigerant R at an intermediate temperature and high pressure expands when being blown out from the injection hole 20C to the entrance passage 25a and becomes the refrigerant R at a low temperature and low pressure. Accordingly, in this embodiment, the refrigerant R is directly supplied to the cooling jacket passage 25, and the mechanical seal 30 (particularly, the secondary seal 33) can more efficiently be cooled. Note that as described above, regardless of presence or absence of the injection hole 20C, the expansion valve 67c as an electronic expansion valve may be used.

### Working and Effects

Next, working and effect of the motor system S according to the present embodiment will be described.

The motor system S according to the present embodiment is the motor system S for cooling the mechanical seal 30 provided for the rotating shaft 13 of the motor M, the motor system S including: the mechanical seal 30 that has the rotating ring 31 mounted on the rotating shaft 13 and the fixed ring 32 fixed to the casing 20 of the motor M via the secondary seal 33 and that is configured such that the rotating ring 31 and the fixed ring 32 abut each other at predetermined pressure in the axis direction Y of the rotating shaft 13; and the refrigerant circulation circuit 60 that circulates the refrigerant R in the refrigerant channel 61 passing through the motor M and cools the motor M, characterized in that the refrigerant R is the CO₂ refrigerant, the refrigerant circulation circuit 60 includes the tank 42 for storing the refrigerant R, the compressor 63 which compresses the refrigerant R supplied from the tank 42, the heat exchanger 64 which causes the compressed refrigerant to dissipate heat, and the expansion valve 67c which expands the refrigerant R resulting from heat dissipation, the cooling jacket passage 25 which causes the refrigerant R to flow so as to pass through the vicinity of the fixed ring 32 and/or the secondary seal 33 is formed in the casing 20, and the refrigerant channel 61 is configured to guide the refrigerant R, which is expanded by the expansion valve 67c, at least to the cooling jacket passage 25.

In the present embodiment configured in such a manner, a configuration is made such that the cooling jacket passage 25 which causes the refrigerant R to pass therethrough for cooling the mechanical seal 30 is formed in the casing 20 and the casing 20 functions as a cooling jacket. In addition, in the present embodiment, a configuration is made such that the refrigerant R at a low temperature and low pressure, which is expanded by the expansion valve 67c, is guided to the cooling jacket passage 25. In such a configuration, in the present embodiment, the mechanical seal 30 can effectively be cooled, and degradation of the mechanical seal 30 can be inhibited.

Further, in the present embodiment, the cooling jacket passage 25 has: the entrance passages 25a each of which extends from an inner side surface of the casing 20 along the axis direction Y and receives the refrigerant R; the cooling passage 25c which communicates with the entrance passages 25a, extends around the rotating shaft 13 in the casing 20, and causes the refrigerant R to pass through the cooling passage 25c; and the exit passage 25b which communicates with the cooling passage 25c and is for discharging the refrigerant R from the cooling passage 25c. In the present embodiment configured in such a manner, while stress concentration which can occur in the casing 20 is inhibited by formation of the cooling jacket passage 25, the mechanical seal 30 mounted on the casing 20 can be cooled by the refrigerant R which passes through the cooling jacket passage 25.

Further, in the present embodiment, the motor M has an oil supply unit (e.g., oil supply) 20A which blows or supplies the lubricating oil L to a sliding portion of the mechanical seal 30, and in an inner space F, which is surrounded by the casing 20, of the motor M, the exit passage 25b opens in a position to which the lubricating oil L is not directly blown from the oil supply unit 20A. In the present embodiment configured in such a manner, because the refrigerant R to be discharged from the exit passage 25b is not obstructed by the lubricating oil L to be blown from the oil supply unit 20A, the refrigerant R can efficiently be caused to flow through the cooling jacket passage 25.

Further, in the present embodiment, the refrigerant channel 61 communicates with the cooling jacket passage 25 via the arrangement space F, in which the mechanical seal 30 is arranged, in the casing 20. In the present embodiment configured in such a manner, before the refrigerant R is supplied to the cooling jacket passage 25, the mechanical seal 30 can be cooled by the refrigerant R in the seal arrangement space F.

Further, in the present embodiment, the refrigerant channel 61 communicates with the cooling jacket passage 25 not via the arrangement space F, in which the mechanical seal 30 is arranged, in the casing 20. In the present embodiment configured in such a manner, the refrigerant R is efficiently sent to the cooling jacket passage 25, and the fixed ring 32 and the secondary seal 33 can thereby effectively be cooled.

Further, in the present embodiment, the refrigerant circulation circuit 60 is provided with the delivery valve 65c for controlling a flow of the refrigerant R, the motor system S further includes the temperature sensor 49 that measures the temperature T of the mechanical seal 30 and the controller 50 that controls opening-closing actions of the delivery valve 65c, and in a case where the temperature T measured by the temperature sensor 49 is equal to or higher than the predetermined threshold value temperature Tth (Yes in S13), the controller 50 opens the delivery valve 65c and causes the refrigerant R to flow toward the mechanical seal 30. In the present embodiment configured in such a manner, when the temperature T of the mechanical seal 30 is low and cooling by the refrigerant R is not necessary, an operation load of the refrigerant circulation circuit 60 is reduced, and power saving can thereby be achieved.

### REFERENCE SIGNS LIST

13 rotating shaft
20 casing
20a internal channel
21 housing
23 end cover
22b, 22c internal channel
24 bulging portion
25 cooling jacket passage
25a entrance passage
25b exit passage
25c cooling passage
30 mechanical seal
31 rotating ring
32 fixed ring
33 secondary seal
40 lubricating oil circulation circuit
41 channel
46 delivery valve
50 controller
60 refrigerant circulation circuit
61 channel
65c delivery valve
67c expansion valve
F seal arrangement space
L lubricating oil
R refrigerant
S motor system

1. A motor system for cooling a mechanical seal provided for a rotating shaft of a motor, the motor system comprising:
a mechanical seal that has a rotating ring mounted on the rotating shaft and a fixed ring fixed to a casing of the motor via a secondary seal and that is configured such that the rotating ring and the fixed ring abut each other at predetermined pressure in an axis direction of the rotating shaft; and
a refrigerant circulation circuit that circulates a refrigerant in a refrigerant channel passing through the motor and cools the motor, wherein
the refrigerant circulation circuit includes a tank in which the refrigerant is stored, a compressor configured to compress the refrigerant supplied from the tank, a heat exchanger configured to cause the compressed refrigerant to dissipate heat, and an expansion valve configured to expand the refrigerant resulting from heat dissipation,
a cooling jacket passage configured to cause the refrigerant to flow so as to pass through a vicinity of the fixed ring and/or the secondary seal is in the casing, and the refrigerant channel is configured to guide the refrigerant, which is expanded by the expansion valve, at least to the cooling jacket passage.

2. The motor system according to claim 1, wherein the cooling jacket passage includes:
an entrance passage which extends from an inner side surface of the casing along the axis direction and receives the refrigerant;
a cooling passage in fluid communication with the entrance passage, the cooling passage extending around the rotating shaft in the casing, and causing the refrigerant to pass through the cooling passage; and
an exit passage in fluid communication with the cooling passage, the exit passage being configured to discharge the refrigerant from the cooling passage.

3. The motor system according to claim 2, wherein:
the motor has an oil supply which blows lubricating oil to a sliding portion of the mechanical seal, and
in an inner space, which is surrounded by the casing, of the motor, the exit passage opens in a position to which the lubricating oil is not directly blown from the oil supply.

4. The motor system according to claim 1, wherein the refrigerant channel is in fluid communication with the cooling jacket passage via an arrangement space, in which the mechanical seal is arranged, in the casing.

5. The motor system according to claim 1, wherein the refrigerant channel is in fluid communication with the cooling jacket passage not via an arrangement space, in which the mechanical seal is arranged, in the casing.

6. The motor system according to claim 1, wherein:
the refrigerant circulation circuit includes a delivery valve for controlling a flow of the refrigerant,
the motor system further includes a temperature sensor configured to measure a temperature of the mechanical seal and a controller configured to control opening-closing actions of the delivery valve, and
in a case where a temperature measured by the temperature sensor is equal to or higher than a predetermined threshold value temperature, the controller is configured to open the delivery valve and causes the refrigerant to flow toward the mechanical seal.

7. The motor system according to claim 2, wherein:
the refrigerant circulation circuit includes a delivery valve for controlling a flow of the refrigerant,
the motor system further includes a temperature sensor configured to measure a temperature of the mechanical seal and a controller configured to control opening-closing actions of the delivery valve, and
in a case where a temperature measured by the temperature sensor is equal to or higher than a predetermined threshold value temperature, the controller is configured to open the delivery valve and causes the refrigerant to flow toward the mechanical seal.

8. The motor system according to claim 3, wherein:
the refrigerant circulation circuit includes a delivery valve for controlling a flow of the refrigerant,
the motor system further includes a temperature sensor configured to measure a temperature of the mechanical seal and a controller configured to control opening-closing actions of the delivery valve, and
in a case where a temperature measured by the temperature sensor is equal to or higher than a predetermined threshold value temperature, the controller is configured to open the delivery valve and causes the refrigerant to flow toward the mechanical seal.

9. The motor system according to claim 4, wherein:
the refrigerant circulation circuit includes a delivery valve for controlling a flow of the refrigerant,
the motor system further includes a temperature sensor configured to measure a temperature of the mechanical seal and a controller configured to control opening-closing actions of the delivery valve, and
in a case where a temperature measured by the temperature sensor is equal to or higher than a predetermined threshold value temperature, the controller is configured to open the delivery valve and causes the refrigerant to flow toward the mechanical seal.

10. The motor system according to claim 5, wherein:
the refrigerant circulation circuit includes a delivery valve for controlling a flow of the refrigerant,
the motor system further includes a temperature sensor configured to measure a temperature of the mechanical seal and a controller configured to control opening-closing actions of the delivery valve, and
in a case where a temperature measured by the temperature sensor is equal to or higher than a predetermined threshold value temperature, the controller is configured to open the delivery valve and causes the refrigerant to flow toward the mechanical seal.

11. The motor system according to claim 1, wherein the refrigerant is a CO₂ refrigerant.

12. The motor system according to claim 2, wherein the refrigerant is a CO₂ refrigerant.

13. The motor system according to claim 3, wherein the refrigerant is a CO₂ refrigerant.

14. The motor system according to claim 4, wherein the refrigerant is a CO₂ refrigerant.

15. The motor system according to claim 5, wherein the refrigerant is a CO₂ refrigerant.

16. The motor system according to claim 6, wherein the refrigerant is a CO₂ refrigerant.

17. The motor system according to claim 7, wherein the refrigerant is a CO₂ refrigerant.

18. The motor system according to claim 8, wherein the refrigerant is a CO₂ refrigerant.

19. The motor system according to claim 9, wherein the refrigerant is a CO₂ refrigerant.

20. The motor system according to claim 10, wherein the refrigerant is a CO₂ refrigerant.
